(19) United States
(12) Patent Application Publication
(10) Pub. No.: US 2026/0010776 A1
(43) Pub. Date: Jan. 8, 2026

(54) NEURAL COMPRESSION AND/OR DECOMPRESSION OF SPATIAL DATA

(71) Applicant: GDM Holding LLC, Mountain View, CA (US)

(72) Inventors: Piotr Mirowski, London (GB); David Warde-Farley, London (GB); Mihaela Claudia Rosca, London (GB); Hyunjik Kim, London (GB); Matthew Koichi Grimes, London (GB); Melanie Rey, Zurich (CH); Shakir Mohamed, London (GB); Yana Hasson, London (GB)

(21) Appl. No.: 19/247,213

(22) Filed: Jun. 24, 2025

Related U.S. Application Data
(60) Provisional application No. 63/667,648, filed on Jul. 3, 2024.

(51) Int. Cl. G06N 3/0495; G01W 1/10; G06N 3/0475

(52) U.S. Cl. CPC G06N 3/0495; G01W 1/10; G06N 3/0475

(57) ABSTRACT

Implementations relate to neural compression and/or decompression of spatial data, such as a dense time series of spatial data. Neural compression can include obtaining an instance of spatial data, stored with a first quantity of bytes, and projecting the spatial data into images. A neural network encoder can be used in generating a corresponding compressed representation for each image, with a reduced dimension relative to the image dimension. The compressed representations are collectively stored with a second quantity of bytes, which is less than the first quantity of bytes. Neural decompression can include obtaining a compressed representation, of spatial data, that is stored with a second quantity of bytes that is less than a first quantity of bytes of the spatial data. A neural network decoder can be used in processing the compressed representation to generate a reconstructed image, which is projected into a geographic coordinate system.

### BACKGROUND

Spatial data, such as dense time series of high-dimensional atmospheric states, can be useful for various purposes such as training and/or validating machine learning models. However, such spatial data can comprise an enormous amount of data. For example, 40 years of raw atmospheric data at ERA5's full complement of 137 elevation levels, at 0.25° (28 km at equator) spatial resolution, and 1-hour temporal resolution requires 181 terabytes of storage per variable. For six variables, a single trajectory exceeds one petabyte of storage.

Storing such a large volume of data can be burdensome. For example, many devices are incapable of storing such a large volume of data and storing it in cloud storage can consume significant resources and/or require transmitting such data over network(s) (e.g., the Internet). Transmitting such data over network(s) (e.g., for storage and/or for use) can negatively impact limited network resources of the network(s).

Various lossless compression methods offer only modest reductions in data size, typically by a factor of less than three. Such modest reductions in data size can be insufficient to address the scale of spatial data challenges. While some lossy compression techniques exist, many are designed to minimize mean squared error (MSE), a metric that often leads to the attenuation of high spatial frequencies. This can result in scientifically problematic distortions, such as the smoothing out or outright erasure of critical physical phenomena like hurricanes or sharp atmospheric fronts. This limitation means that relying on generic lossy compression can compromise the fidelity and scientific utility of reconstructed data that is reconstructed from generic lossy compression. For example, such reconstructed data can fail to preserve the extreme values and discontinuities that are crucial for accurate analysis and prediction.

### SUMMARY

Implementations described here relate to neural compression and/or decompression of spatial data, such as a dense time series of spatial data. For example, the spatial data can be time series data (e.g., for every hour, day, week, or other interval) for a geographic region (e.g., a state, a country, a continent, multiple countries, the Earth). For instance, the spatial data can be a dense time series of high-dimensional atmospheric states, such as atmospheric states for each of a plurality of geographical segments (e.g., each at 0.25° or other resolution) and for each of a plurality of elevation levels.

Some implementations that pertain to neural compression of spatial data obtain an instance of spatial data. The instance of spatial data is stored with a first quantity of bytes and defines, for each of a plurality of geographical segments of a geographic coordinate system (GCS), a corresponding value for each of one or more variables. Those implementations project the instance of spatial data into a plurality of images, where each image corresponds to a unique geographical area encompassing a unique contiguous set of geographical segments and is generated based on values for that set. Each image has an image dimension including a height, a width, and one or more image channels. Those implementations further generate, using a neural network encoder, a corresponding compressed representation for each image. Each compressed representation has a reduced dimension relative to the image dimension, and the compressed representations are collectively stored with a second quantity of bytes that is less than the first quantity of bytes. Put another way, the first quantity of bytes, with which the instance of spatial data is stored, is greater than the second quantity of bytes with which the compressed representation is stored. Yet further, those implementations further store the corresponding compressed representations in one or more computer-readable media. The stored corresponding compressed representations can be utilized for one or more of various purposes.

Some implementations that pertain to neural decompression/reconstruction of spatial data obtain a compressed representation of an image. The image can be one generated based on projecting values from spatial data for a contiguous set of geographical segments of a geographic coordinate system (GCS). For example, the image can be one generated based on neural compression techniques disclosed herein. The compressed representation of the image is stored with a second quantity of bytes that is less than a first quantity of bytes of the original values from the spatial data based on which the image is generated. Those implementations further process the compressed representation, using a neural network decoder, to generate a reconstructed image, and then project the reconstructed image into the GCS to generate reconstructed spatial data.

Implementations disclosed herein provide various technical advantages, including significant reductions in data storage requirements, enabling the efficient storage and transmission of large volumes of spatial data such as atmospheric states. For example, in various implementations the quantity of bytes required for storing the compressed representations of spatial data can be at least, five hundred times less, eight hundred times less, nine hundred times less, or one thousand times less than the quantity of bytes required for storing the spatial data, substantially reducing resource requirements for storing and transmitting high-resolution spatial datasets. Implementations can also facilitate the processing of spatial data for various applications, such as generating predictions using machine learning models from the compressed or reconstructed data.

As a non-limiting example of some compression implementations disclosed herein, consider a meteorological center that processes vast quantities of atmospheric data, such as temperature, pressure, and wind speed, across a global grid at high spatial and temporal resolutions. Initially, an instance of this data, representing a full global atmospheric state for a specific time, is obtained and stored in a high-fidelity format, occupying a first quantity of bytes—perhaps tens of terabytes for a single instance. To manage this immense volume, one or more processors project this spatial data into a plurality of images. Each image corresponds to a distinct geographical area of the globe, encompassing a unique contiguous set of the geographical segments (e.g., specific regions like all or parts of North America, Europe, or oceanic expanses), and is generated based on the atmospheric values for that particular region. Each image is structured with multiple channels (e.g., one channel for temperature at a first elevation, another channel for temperature at a second elevation, another channel for pressure, etc.), and defined height and width dimensions. Subsequently, a neural network encoder is used to process each of these images to generate a corresponding compressed representation for each of these images. Each compressed representation has a dimension that is significantly reduced relative to the original image dimension. For instance, a 256×256 image with multiple channels might be compressed into a 32×32 representation. These compressed representations, for all images, are then collectively stored in computer-readable media, occupying a second quantity of bytes that is substantially less than the first quantity of bytes of the original spatial data, thereby enabling efficient storage and potential transmission for further meteorological analysis or model training.

As another non-limiting example of some decompression implementations disclosed herein, consider a scenario where a meteorological center has successfully compressed a vast dataset of global atmospheric conditions for a specific temporal period, where the initial values were stored with a first quantity of bytes. A remote research station, possessing limited local storage and computational resources, needs to access and analyze a specific portion of this atmospheric data, which was previously projected into an image representing a contiguous set of geographical segments (e.g., a specific hurricane event captured in a 256×256 pixel image). The research station's one or more processors obtain a compressed representation of this image, which is stored with a second quantity of bytes that is substantially less than the first quantity of bytes of the original values. Subsequently, a neural network decoder is utilized to process this compressed representation, thereby generating a reconstructed image that approximates the original atmospheric data for that specific geographical area. This reconstructed image is then projected into the GCS or other coordinate system to generate reconstructed spatial data, allowing analysis of the atmospheric data with sufficient fidelity, without requiring any transmission of the entire uncompressed dataset.

Some implementations include a transitory or non-transitory computer readable storage medium storing instructions executable by a processor to perform a method such as one or more of the methods described herein. Some implementations include a system including memory and one or more processors operable to execute instructions, stored in the memory, to implement one or more modules or engines that, alone or collectively, perform a method such as one or more of the methods described herein.

The preceding is presented as a non-limiting overview of only some implementations disclosed herein. The appended paper and the claims provide additional details on those and other implementations.

### BRIEF DESCRIPTION OF THE DRAWINGS

FIG. 1 is a block diagram illustrating an example system that performs spatial data compression and reconstruction.

FIG. 2 is a block diagram illustrating an example Vector Quantized Variational Autoencoder (VQ-VAE) and Generative Adversarial Network (GAN) Discriminator architecture.

FIG. 3 is a block diagram illustrating an example hyperprior network.

FIG. 4 is a flowchart illustrating an example method for spatial data compression.

FIG. 5 is a flowchart illustrating an example method for spatial data reconstruction.

FIG. 6 is a block diagram illustrating an example computing system.

### DETAILED DESCRIPTION

Prior to turning to the Figures, a non-limiting description of some example aspects of the disclosure is provided.

Atmospheric states derived from reanalysis comprise a substantial portion of weather and climate simulation outputs. Many stakeholders, such as researchers, policy makers, and insurers, utilize this data to better understand the earth system and guide policy decisions. Atmospheric states have also received increased interest as machine learning approaches to weather prediction have demonstrated promising results. A key issue for all audiences is that dense time series of these high-dimensional states comprise an enormous amount of data, precluding all but the most well-resourced groups from accessing and using historical data and future projections.

To address these and other problems, implementations are disclosed herein for compressing atmospheric states, adapting spherical data for processing by neural architectures through use of an area-preserving HEALPix projection. Various non-limiting examples of neural architectures that can be utilized for such processing are described herein and include a hyperprior model, originating from neural image compression, and vector-quantized models. Some of those architectures satisfy specific desiderata, including small average error, a small number of high-error reconstructed pixels, faithful reproduction of extreme events such as hurricanes and heatwaves, and preservation of the spectral power distribution across spatial scales. Some implementations disclosed herein provide compression ratios in excess of 1000×, with compression and decompression occurring at a rate of approximately one second per global atmospheric state.

Implementations disclosed herein present neural network compression methods and systems for simulated atmospheric states, with the aim of reducing the currently immense storage requirements of such data from cloud scale (e.g., petabytes) to desktop scale (e.g., terabytes). This need for compression has emerged over the past 50 years, characterized by a steady push to increase the resolution of atmospheric simulations, which increases the size and storage demands of the resulting datasets. Concurrently, atmospheric simulation has come to play an increasingly significant role in scientific, industrial, and policy-level pursuits. Higher spatial resolutions provide simulators with the capability to deliver more accurate predictions and resolve an increasing number of atmospheric phenomena. For example, while current models often operate at 25-50 km resolution, resolving storms can require 1 km resolution, and resolving the motion and radiative effects due to low clouds can require 100 m resolution. Machine learning models for weather prediction also face opportunities and challenges with higher resolution: while additional granularity may afford improved modeling opportunities, even the present size of atmospheric states poses a significant bottleneck for loading training data and serving model outputs.

To illustrate the data storage problem, storing 40 years of reanalysis data from a prevalent reanalysis dataset at full spatial and temporal resolution (i.e., without subsampling) can require 181 TB of storage per atmospheric variable. For six such variables, a single trajectory can exceed 1 PB, disregarding an ensemble of tens or hundreds of trajectories, which can be required for model intercomparison or for predicting distributions of outcomes. As noted in the field, climate research generates substantial data volumes at rapid rates, for example, 260 TB of data every 16 seconds. Such conditions create considerable difficulties, prompting researchers to discard data or decrease temporal and/or spatial resolution. The necessity to decimate datasets to satisfy financial and/or engineering constraints can be particularly detrimental for machine learning models, as their performance is frequently bounded by the size of the training dataset.

Numerous off-the-shelf algorithms are available for data compression. However, for continuous-valued data such as atmospheric states, modern lossless compression methods tailored to such data typically offer only modest savings, reducing the size by only a factor of two. Existing lossy compression algorithms present their own issues, as they are usually designed to compress while optimizing mean squared error (MSE). In the weather and climate domain, the MSE loss in particular can attenuate high spatial frequencies, thereby removing physically important spatial discontinuities. A naive pursuit of reduced MSE can result in significant, scientifically problematic distortions, including the outright erasure of entire hurricanes. This motivates the development of bespoke compression methods evaluated with consideration for not just MSE but also other physical metrics of scientific interest, such as power spectrum distortion and the preservation of extrema.

Based on problems such as those described above, implementations disclosed herein seek to achieve one or more of the following advantages: high compression rates, low error (on average and/or for extreme values), and fast/processor efficient execution. These advantages enable utilization of atmospheric datasets in full without the need for subsampling, increase the speed of data dissemination at all levels, and/or reduce storage costs. In pursuit of this goal, compression methods based on autoencoder neural networks are presented, which are adapted and trained for atmospheric data. These compression methods illustrate and exploit the informational redundancy of atmospheric states. A system based on a hyperprior model is presented as a candidate neural compressor that satisfies the requirements of atmospheric state compression. As an illustrative example, compression results for a hurricane event are presented, which demonstrate low errors across physical variables of interest, as well as the ability to preserve extreme values and events.

Implementations disclosed herein can include one or more of four stages: reprojecting an atmospheric state to a square format better suited for machine learning accelerators using a HEALPix projection, employing a neural encoder to map these projections into a discrete representation (which can be losslessly compressed with standard techniques), reconstructing HEALPix projections using a neural decoder, and finally reprojecting back onto an equirectangular latitude/longitude grid using a spherical harmonics transform. Approaches disclosed herein are capable of compressing these data at low error by orders of magnitude, and thus demonstrate bespoke high-compression methods applicable to multi-decadal data. Approaches disclosed herein can achieve a mean absolute error (MAE) of approximately 0.4° K for temperature, approximately 0.5 m/s for zonal and meridional wind, below 1 hPa for surface pressure, and/or approximately 40 m²/s² for geopotential, with less than 0.5% of HEALPix pixels exceeding an error of 1° K (temperature), 1 m/s (zonal and meridional wind), and/or or less than 0.05% of pixels exceeding an error of 100 m²/s² (geopotential), while preserving spectral shape. Encoding and decoding can occur at a rate of approximately one second per global atmospheric state. High-error pixels are sufficiently rare that their values can be stored in a lookup table while maintaining an overall compression ratio above 800, 900, or 1,000. Because sharp features and rare events can be highly susceptible to aggressive compression, an analysis of weather events of interest, such as hurricanes and heat waves, is performed to demonstrate that these are not distorted in various implementations disclosed herein.

Compression methods can be categorized as lossless or lossy. Lossless compression seeks to transform data such that the original data can be recovered precisely. As digital information is inherently discrete, lossless compression techniques typically operate on an assumption that their input comprises a sequence of discrete tokens. Even though continuous-valued datasets are encoded as finite, binary strings, general purpose lossless compression methods often exhibit suboptimal performance due to an absence of readily discoverable statistical structure within the binary representation. For example, compression ratios (defined as the ratio of the original data size to the compressed size) of less than 3 have been observed for various lossless compression algorithms when applied to continuous-valued scientific datasets. For many resource allocations, reducing a 100 PB atmospheric trajectory ensemble to 33 PB would not adequately address data storage challenges.

In the context of physical simulations, one approach involves storing trajectories as a sparse set of checkpoint frames at regular time intervals, and subsequently re-simulating the discarded frames from the nearest preceding checkpoint. The resulting compression ratio is dependent on the spacing of the frames, and re-simulation may incur substantial computational expense. Various implementations described herein do not presuppose the existence of, or access to, an original data simulator.

Lossy compression methods, in contrast, permit a degree of distortion in the recovered signal after decompression. An inherent tension exists between the extent of compression (referred to as the code's rate) and the magnitude of incurred distortion, which is commonly termed the rate-distortion trade-off. The acceptable type and degree of distortion are highly dependent on the application domain. Therefore, the quantification and mitigation of application-relevant distortions are important to the design of effective compression methods. Furthermore, leveraging domain-specific knowledge allows for the exploitation of known statistical regularities in the data, thereby facilitating higher compression levels at a predetermined distortion threshold.

Several error-bounded lossy compression algorithms have been designed for floating-point arrays. Among these, implementations of SZ3 and ZFP have been observed to achieve approximately 50× compression. A prior method proposes utilizing lower-precision numbers to represent atmospheric states, effectively discretizing floating-point numbers by rounding them. This approach has achieved compression ratios of up to 155 for temperature, with a median error of approximately 0.4° C.

Implementations of approaches disclosed herein are understood within the paradigm of transform coding, which underpins various methods for the compression of natural signals such as images, audio, and video. In transform coding, an original signal is invertibly mapped into an alternative domain deemed more suitable for lossy scalar quantization. For example, certain elements of the transformed representation are less crucial to perceived quality for the reconstruction. A stream of bits representing indices in the reduced set of quantized scalars is then losslessly compressed via entropy coding. The invertible transform is typically linear, such as the discrete cosine transform utilized in the JPEG format on small square sub-regions, and is designed to produce a collection of relatively uncorrelated scalars. Traditionally, the transform, quantization, and entropy coding steps form wholly separate subsystems of a compression pipeline. While this modularity affords implementation benefits, recent advances in machine learning have demonstrated that quantization can be directly and advantageously incorporated into scalable representation learning systems. Implementations of this disclosure explore two such families of methods, the latter of which also employs a relaxation of the entropy coding objective to directly parameterize the rate-distortion trade-off.

Implementations disclosed herein build upon the autoencoder family, a type of parameterized non-linear mapping, such as a neural network. This mapping is conceptualized as a combination of an “encoder” function and a “decoder” function, which is fit to data. The objective of such a system is to reproduce its own input from an alternative representation. Given that the identity function is otherwise trivially representable, specific constraints imposed on the functional form of an autoencoder (such as a low-dimensional “bottleneck” between the encoder and decoder, or penalties applied during optimization) direct the learning procedure toward descriptive parsimony. Probabilistically motivated autoencoder variants have achieved widespread application in learning low-dimensional data representations, and possess an established connection to compression theory. This connection is formalized in various ways through the minimum description length principle and bits-back-encoding, as well as variational inference.

In contrast to autoencoders, a different line of research employs neural networks to directly represent continuous data by mapping spatial coordinates to their corresponding data values. For example, the pixels of a single photograph can serve as a “dataset” from which a network is trained to map pixel coordinates (i, j) to the corresponding pixel color (r, g, b). Once trained, the network's parameters function as the compressed representation, which can be considerably more compact than the raw data array they encode. Such an approach has been demonstrated on atmospheric data across a wide range of compression ratios. However, a disadvantage of this approach is the requirement for training or fine-tuning the model for each new data point.

Within an autoencoder, the encoder maps rich, high-dimensional signals to lower-dimensional codes that are more suitable for storage or transmission. These codes can then be lossily reconstructed by applying the decoder. The encoder-decoder framework offers several advantages. After training, the encoder can be applied to data beyond its training set. The compressed representation can be structured to maintain the same spatial layout and topology as the input data, which can facilitate interpretability. Of particular interest are strategies for learning discrete representations with autoencoders, which may enable lossless compression and can facilitate direct, downstream application with sequence models, such as transformers. Several families of such autoencoders, which achieve discrete representations using two distinct strategies, are further described herein.

A vector-quantized variational autoencoder, or VQ-VAE, is a neural network configured to map input data to a set of discrete indices within a learned codebook of vector-valued codes. A continuous neural encoder maps an input data set to a continuous code layer. While certain autoencoders rely on amortized inference by an encoder of sufficient statistics of continuous random variables and a “reparameterization trick” to obtain differentiable samples, the VQ-VAE defines a degenerate variational posterior in which components of the latent representation adopt the closest, in Euclidean distance, of N distinct values from a learned codebook D. In the case of images, convolutional architectures are employed for the encoder and decoder. A vector at each spatial location in the lower dimensional, final layer spatial map is quantized to values from a codebook shared across all spatial locations. The encoder and decoder can be trained end-to-end by minimizing the L2 norm between the input data and corresponding reconstructions. During this optimization, gradients through the non-differentiable quantizing operation can estimated by ignoring it and substituting an identity function. Additional loss functions can steer codebook entries toward an output of the encoder while also encouraging the encoder to select between codebook entries rather than predict convex combinations thereof.

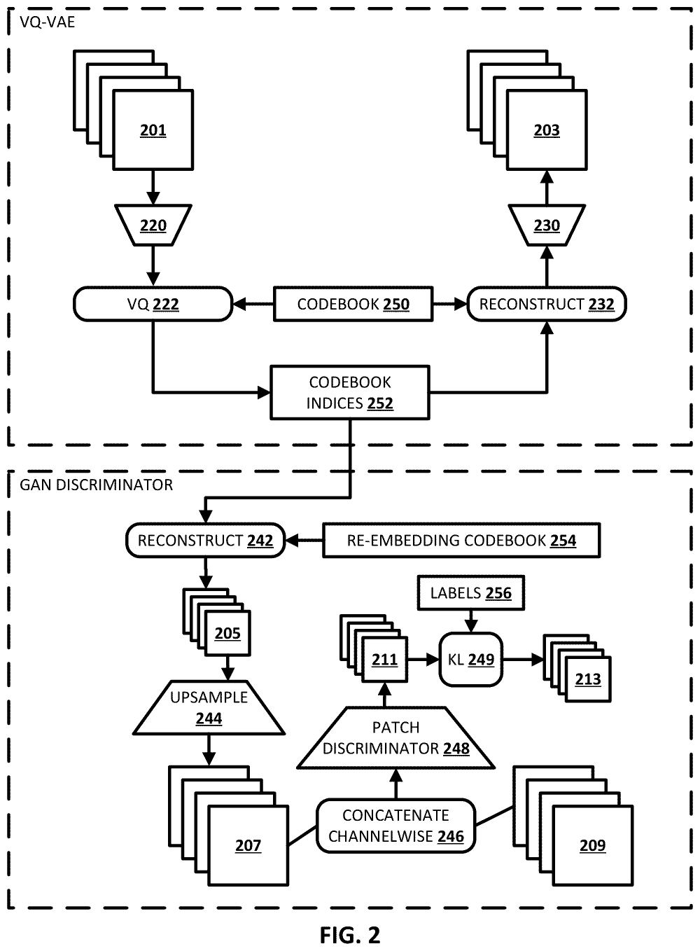

Once quantized, an encoded value can be parsimoniously represented as an integer index from 1 to N. Beyond the compression that results from replacing a multi-channel image with a much smaller array of integers, the resulting map can be further compressed with standard entropy-coding techniques, potentially exploiting both non-uniformity of codebook usage and spatial correlations in the resulting low-dimensional maps. FIG. 2 (described below) illustrates an example VQ-VAE network, depicting the encoder, decoder, and codebook reconstruction.

Naively optimizing mean squared error can have unacceptable consequences for atmospheric states, as its tendency to wash out sharp features can erase the very events climate scientists wish to measure, such as hurricanes. For this reason, VQ-GANs can be utilized, which augment a VQ-VAE by adding a patch-wise discriminator and are trained with an auxiliary adversarial loss term. During training, the discriminator receives the quantized feature map indices, channel-wise concatenated (after upsampling and continuous embedding) with either the original atmospheric data from which it was computed or its corresponding reconstruction. The discriminator is trained to maximize its classification accuracy on discriminating patches of real data from reconstruction patches, while the encoder-decoder pipeline is trained to reconstruct its input well while minimizing this accuracy. For both VQ-VAE and VQ-GAN implementations, neural network architectures similar to certain prior neural network architectures can be used. FIG. 2 further illustrates a GAN discriminator that can be utilized as patch-wise discriminator in training the encoder and the decoder of the VQ-VAE.

A factorized prior model discretizes an individual element of a latent vector by rounding to integers at test time. This is approximated during training as a zero-mean scalar noising function in the same spirit as the reparameterization described above. Unlike the vector quantized (VQ) models described earlier, an objective function of the factorized prior is explicitly derived with data compression in mind, and a continuous relaxation of a Shannon entropy of the resulting discrete code comprises an additional loss term. Probabilistically speaking, an encoder-decoder pair are trained to optimize a variational lower bound on an expected log-likelihood of data modeled by latent variables with a prior consisting of independent uniform random variables (hence, “factorized”) and an isotropic Gaussian likelihood.

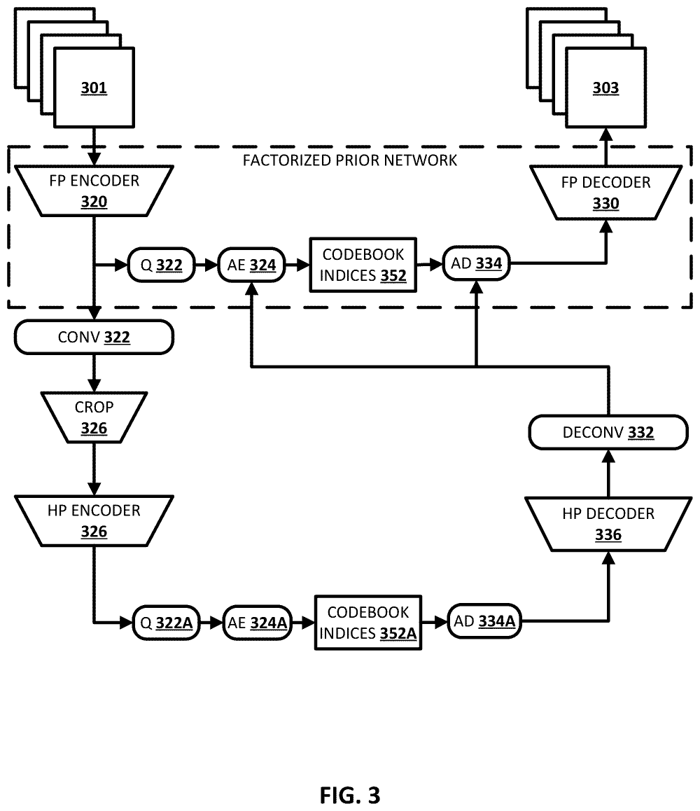

A hyperprior model is an extension which, for training purposes, composes two factorized prior autoencoders. A first block's encoder produces a feature map, which is quantized to integers. As is common in convolutional feature maps, the pixels of a quantized feature map retain local spatial correlations. A second autoencoder implements, with a same variational approach (though a different likelihood function) a probabilistic generative model which captures these correlations, introducing a new, smaller set of latent variables. The probabilistic model defined by this secondary autoencoder is used to more effectively entropy code the first model's quantized maps by predicting the scale (i.e., modeling the variance) of each element of a feature map conditioned on encoded, quantized secondary latent variables, which are themselves entropy-coded and stored alongside resulting encodings of the quantized feature map. FIG. 3 (described below) illustrates a network schematic for a non-limiting example of a hyperprior model. The hyperprior model is considered suitable as a neural compressor that performs well across various requirements.

A naive compression ratio for a VQ-VAE or VQ-GAN model would be in dividing a storage space needed for representing input data (e.g., 5 vertical variables times 256×256 pixels of 32-bit floating point data) versus a storage space needed by compressed vector-quantized maps (e.g., for a VQ-VAE with 3 downsampling blocks, 32×32 indices of a 13-bit dictionary with=8192 elements). For this specific example, the compression ratio is about 788. In entropy coding, further reduction in a storage footprint can occur, and the compression ratio is estimated to be approximately 1100× for that model architecture when compressing data.

In some implementations of this description, storage cost in bits is estimated as an empirical Shannon entropy of codebook indices per grid. This notably ignores expected spatial correlations in an encoded representation (for which the hyperprior model explicitly accounts). The obtained compression ratios for VQ models could thus be improved by fitting a secondary autoregressive model on codebook index maps. The compression ratios obtained with this simplistic entropy computation thus serve as a conservative lower bound.

The representation and projection of the initial data that is to be compressed can be a consideration in the design of neural compression methods. Atmospheric data lies on a sphere, whereas numerical programming natively operates on rectilinear arrays. The equirectangular latitude/longitude projection suffers from fundamental limitations in that pixels do not represent consistent units of area across the map, ranging from 28 km×28 km at the equator to negligible area at either pole (where the grid heavily oversamples). To address these limitations, there exist a multitude of alternative gridding conventions, with the most common reprojections being octahedral and icosahedral sampling, cubed spheres, dual lat-lon, and locally linear projections.

The Hierarchical Equal Area iso-Latitude Pixelation (HEALPix) projection defines a curvilinear partitioning of the sphere into 12 equal-area base pixels, further subdivided by powers of 2 into a local square coordinate system, which can be sized to the needs of the application. The pixels of a HEALPix grid, when traversed diagonally, lie along lines of constant latitude, making conversion to and from spherical harmonics especially efficient. This ease of conversion to the lingua franca of spherically embedded continuous data makes HEALPix a convenient grid format for conversion to any other grid format. HEALPix is used in astronomy for data situated on the celestial sphere, and is seeing increasing use in atmospheric science.

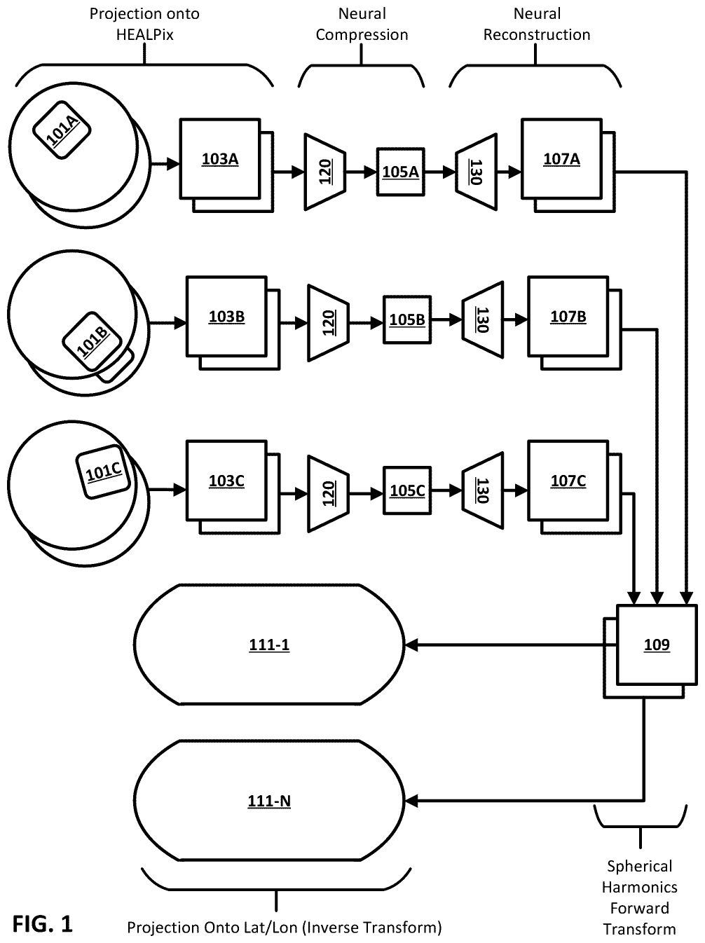

FIG. 1, described below, illustrates the projection of atmospheric data onto HEALPix, and specifically shows three such HEALPix base representations. It also illustrates the forward transform of the HEALPix representations to compute spherical harmonics coefficients (analysis), and the inverse transform of spherical harmonics coefficients to compute latitude/longitude projections (synthesis). To avoid losing high-frequency information, a wavenumber can be chosen (e.g., wavenumber=721), where the wavenumber is equal to the number of latitudes on the latitude/longitude grid and half the number of longitudes during synthesis of the reprojection image, for the spherical harmonics transform. One consideration when using HEALPix is that the round-trip from latitude/longitude representations to HEALPix projections at a chosen resolution to spherical harmonic coefficients back to latitude/longitude reprojection introduces small interpolation errors, which remove some high-frequency information.

In some experimental analysis of implementations disclosed herein, HEALPix with a 256×256 pixel grid is utilized within each of the 12 top-level base pixels, preserving a spatial resolution of around 0.25 degrees per pixel. Implementations also extend HEALPix to support overset grids, which are grids with overlapping domains at the edges. For example, on each side of each 256×256 grid a margin of 16 pixels can be added, whose values are interpolated from the neighboring grids with which they overlap. This enables removing discontinuities between neighboring grids in the decompressed data, by linearly blending between the two grids' values where they overlap.

The utility of neural compression methods can be demonstrated through comparison with error-bound compression. One limitation of neural compression methods for scientific data is the presence of unbounded, and potentially high, maximum element-wise reconstruction errors. The compression techniques disclosed herein achieve robust compression ratios for comparable mean reconstruction errors when contrasted with other methods. To address error bound guarantees, various implementations disclosed herein compress the residuals subsequent to neural compression, utilizing approaches for error-bounded compression to ensure both compression performance and error control. In contrast to methods where a neural network is trained to represent a function over the training data, an autoencoder-based approach provides for generalization to unseen data frames. This presents an advantage as the compression model does not require retraining to process new data frames.

Implementations disclosed herein present a method for the neural compression of atmospheric states, optionally utilizing the area-preserving HEALPix projection to facilitate processing of data situated on a spherical surface by neural networks. This projection selection permits efficient computation of spherical harmonics, thereby simplifying both the reprojection of decompressed atmospheric states to latitude/longitude coordinates and the direct analysis of the spectral properties of the reconstructions. Analysis of the performance characteristics of various neural compression methods demonstrates high compression ratios exceeding 1000× with minimal distortion. The hyperprior model, even with a relatively simple encoder and decoder configuration, appears to be well-suited for this application. The hyperprior model substantially preserves the shape of the power spectrum, despite implementations of its training being solely based on mean squared error and a compressibility penalty.

Some implementations disclosed herein utilize a specific instance of the HEALPix projection that projects the sphere onto 12 diamond-shaped tiles of equal areas: 4 tiles joining at the North Pole and touching the Equator on their opposite corners, 4 equatorial tiles, and 4 tiles joining at the South Pole and touching the Equator. Each tile can be projected onto a square and subdivided into 2″×2″ pixels. 2″ can be selected such that one HEALPix pixel covers an area roughly equivalent to a pixel on the Equator of a lat/lon grid having 721 latitudes by 1440 longitudes. The area of a single HEALPix pixel on a sphere of radius r is 4πr²/(12×2″×2″)≈1.6×10⁻⁵×r² for 2″=256, whereas the area of a single latitude/longitude cell on a grid of Nat latitudes by Nlon longitudes can be approximated to (2πr)²/(Nlon×2 Nlat)≈1.9×10⁻⁵×r². While such a HEALPix mesh contains fewer pixels (only 12×2″×2″=786,432) as opposed to the lat/lon grid at 0.25° (Nlon×Nlat=1,038,240), the latter cells cover increasingly smaller areas close to the poles.

The coordinates of all pixels in HEALPix tiles can be computed using the astropy HEALpix Python software library. Projection from the lat/lon grid onto pixel coordinates of individual HEALPix tiles can be performed using bilinear interpolation over a grid (cos(θ), ϕ) of cosines of latitudes θ and longitudes ϕ. For reprojecting back from HEALPix to lat/lon coordinates, spherical harmonics synthesis can be utilized.

Some image compression models are trained to compress and reconstruct HEALPix tiles independently. As a consequence, small discontinuities can appear at the edges of each reconstructed HEALPix tile, and become apparent when neighboring HEALPix tiles are “stitched” together on the reprojected lat/lon image. To address the problem of discontinuities and stitching artifacts, implementations disclosed herein propose image compression and reconstruction using overset HEALPix meshes by transforming 288×288 input images (where 288=256+16+16, representing 256 pixels plus 16 padding borders on each side of the tile) to 288×288 output images. These resulting input, target, and output images correspond to padded HEALPix tiles.

Padding HEALPix tiles is complicated by the fact that some corners of HEALPix tiles are at the intersection of 4 tiles (the junctions at the Equator, and at the North and South Pole), whereas other corners are at the intersection of 3 tiles (the junction at ±45° latitude). A proposal is to pad HEALPix tiles by copying pixel values from neighboring tiles, but that proposal relies on mirror-padding the polar tiles at the 3-tile junctions. Unlike that approach, some implementations disclosed herein preserve local angles by relying on interpolation and do not involve mirror-padding. Unlike HEALPix coordinates, there is no closed-form calculation for this padding. Instead, extrapolation of HEALPix corners and interpolation between two such extrapolated corners is used to obtain a new 288×288 grid. To blend the HEALPix tiles, the weight of the padding pixels is first computed, which decays linearly from 1 to 0 on each border. Second, the coordinates of the padding borders of each HEALPix tile are computed in the Cartesian space of the sphere. Third, the effect of each HEALPix tile's overlap upon each of its neighbors is interpolated by computing the coordinates of the external tile in the target tile space by projecting the Cartesian coordinates of a tile onto the HEALPix pixels of a neighboring tile. The blended contribution of each HEALPix tile to its neighbors is computed using weighted sums. This results in new 256×256 HEALPix data, on which spherical harmonics are computed for re-projection onto the latitude/longitude grid.

Turning now to the figures, FIG. 1 is a block diagram illustrating an example system that performs spatial data compression and reconstruction. The circles in FIG. 1 are representative of a spherical representation of the Earth.

First geographical area data element 101A defines, for each of one or more variables (e.g., pressure, temperature, humidity, etc.), a corresponding value for each of a plurality of contiguous geographical segments, of a geographic coordinate system (GCS), that are encompassed by the area visually covered by the first geographical area data element 101A. For example, the area visually covered by the first geographical area data element 101A can correspond to all or part of continental Europe and the geographical segments can each be a corresponding 1 km by 1 km portion thereof and can be at one or more elevations thereof. Accordingly, with the example, for each 1 km by 1 km portion of the earth visually covered by the first geographical area data element 101A, there is defined a corresponding value for each of one or more variables for each of one or more elevations. For instance, a 1 km by 1 km portion can have, for each of one or more elevations, a pressure value, a temperature value, and a humidity value. The corresponding values defined by the geographical area data element 101A can be for a corresponding temporal period (e.g., a particular day and a particular time or time range of the day that reflects a time of measurement).

Likewise, second geographical area 101B defines, for each of one or more variables, a corresponding value for each of a plurality of contiguous geographical segments, of the GCS, that are encompassed by the area visually covered by the second geographical area data element 101B and can be at one or more elevations thereof. For example, the area visually covered by the second geographical area data element 101B can correspond to all or part of East Asia and the geographical segments can each be a corresponding 1 km by 1 km portion thereof and can be at one or more elevations thereof. Further, third geographical area 101C defines, for each of one or more variables, a corresponding value for each of a plurality of contiguous geographical segments, of the GCS, that are encompassed by the area visually covered by the third geographical area data element 101C and can be at one or more elevations thereof. For example, the area visually covered by the third geographical area data element 101C can correspond to all or part of the Indian Ocean and the geographical segments can each be a corresponding 1 km by 1 km portion thereof and can be at one or more elevations thereof.

Although three geographical areas 101A, 101B, and 101C are shown in the example of FIG. 1, it is understood that FIG. 1 and other disclosure provided herein can be applied to any suitable number of geographical areas. For example, the geographical areas utilized can collectively encompass the entire Earth. Further, one or more of the geographic areas utilized can partially overlap with one or more other of the geographic areas utilized.

The projection onto HEALPix stage illustrated in FIG. 1 includes projecting the values defined by the first geographical area data element 101A into a first image 103A, projecting the values defined by the second geographical area data element 101B into a second image 103B, and projecting the values defined by the third geographical area data element 101C into a third image 103C. Each of the images 103A, 103B, and 103C can include multiple channels with each of the channels corresponding to a different variable. For example, a first channel of the images 103A, 103B, and 103C can correspond to a first variable, a second channel of the images 103A, 103B, and 103C can correspond to a second variable, and so on. The images 103A, 103B, and 103C can be square images, such as 256×256 pixel square images. HEALPix is an acronym for Hierarchical Equal Area isoLatitude Pixelation of a 2-sphere and can refer to an algorithm for pixelization of a 2-sphere based on subdivision of a distorted rhombic dodecahedron.

The neural compression stage illustrated in FIG. 1 can utilize a neural network encoder 120 to process the images 103A, 103B, and 103C to generate corresponding compressed representations of those images, reflected by quantized representations 105A, 105B, and 105C. For example, the images 103A, 103B, and 103C can each be 256×256 pixel images, and the quantized representations 105A, 105B, and 105C can each be 32×32 representations. Further, in some implementations the images 103A, 103B, and 103C can each include multiple channels, whereas the quantized representations 105A, 105B, and 105C can each include only a single channel.

The neural reconstruction stage illustrated in FIG. 1 can utilize a neural network decoder 130 to process the quantized representations 105A, 105B, and 105C to generate corresponding reconstructed images 107A, 107B, and 107C. For example, the quantized representations 105A, 105B, and 105C can each be 32×32 representations, and the reconstructed images 107A, 107B, and 107C can each be 256×256 pixel images with multiple channels.

A spherical harmonics forward transform stage illustrated in FIG. 1 can utilize a spherical harmonics forward transform module 109 that determines spherical harmonics coefficients for each of the reconstructed images 107A, 107B, and 107C. In determining the spherical harmonics coefficients, the spherical harmonics forward transform module 109 utilizes a forward transform of the reconstructed images 107A, 107B, and 107C. The spherical harmonics transform module 109 can utilize the coefficients to synthesize re-projected reconstruction via inverse transform in latitude/longitude coordinates. Element 111-1 and 111-N in FIG. 1 represents re-projected reconstructions for a first variable “1” and an nth variable “N”. The elements 111-1 and 111-N can represent a flattened globe representation and can include the re-projected reconstructions generated by the spherical harmonics transform module 109. Put another way, the elements 111-1 and 111-N can each include multiple reconstructions generated by the spherical harmonics transform module 109. As indicated by the nth variable “N”, additional re-projected reconstructions can be generated, with each being for an additional variable between the first and the nth variable.

FIG. 2 presents a block diagram illustrating the architecture of a Vector Quantized Variational Autoencoder (VQ-VAE) and an associated Generative Adversarial Network (GAN) Discriminator. In FIG. 2, the VQ-VAE is illustrated as including a neural network encoder 220 and a neural network decoder 230. A vector quantization (VQ) module 222, a codebook 250, codebook indices 252, and a reconstruct module 232 are also illustrated, one or more of which can be used in various implementations in compressing and/or decompressing spatial data as described herein.

The GAN discriminator architecture can optionally be utilized in neural compression and/or decompression. For example, the GAN discriminator can be a patch-wise discriminator and can be utilized in training the VQ-VAE. During training, the GAN discriminator can receive the quantized codebook indices 252, channel-wise concatenated (after upsampling and continuous embedding) with either the original atmospheric data from which it was computed or its corresponding reconstruction. The GAN discriminator can be trained to maximize its classification accuracy on discriminating patches of real data from reconstruction patches, while the VQ-VAE pipeline is trained to reconstruct its input well while minimizing this accuracy.

In FIG. 2, batched original data 201 is illustrated, which can be a batch of original (not reconstructed) HEALPix projected multi-channel images. The batched original data 201 is processed, using the neural encoder 220, to generate a compressed representation of the batched original data 201. The VQ module 222 processes (e.g., quantizes) the compressed representation from the neural encoder 220, using the codebook 250, to generate the codebook indices 252. The reconstruct module 232 processes (e.g., dequantizes) the codebook indices 252, using the codebook 250 and provides the processed (e.g., dequantized) data for processing, using the neural decoder 230, to generate batched reconstructed data 203, which can be a batch of reconstructed HEALPix multi-channel images, that seek to be accurate reconstructions of the batched original data 201.

The neural encoder 220 can be used to process an original image of the batched original data 201 to generate a 32×32 (or other reduced dimension) encoding thereof. The VQ module 222 can, for example, quantize each vector in the reduced dimensionality encoding that is generated using the neural encoder 120, by finding the closest matching vector in a discrete codebook 250. This can involve comparing the continuous latent vectors to a predefined set of learned discrete vectors within the codebook 250. The codebook 250 can function as a dictionary of learned vector-valued codes. For example, if the codebook contains 8192 unique vectors, the VQ module 222 can select one of these 8192 vectors that is closest to each input latent vector. This selection results in codebook indices 252, which can be discrete integer values. The codebook indices 252, for example, can each represent a highly compressed version of an original one of the images of the batched original data 201, where each index points to a specific learned vector in the codebook, significantly reducing the data quantity.

The reconstruct module 232, for example, retrieves the actual vector-valued codes from the codebook 250 corresponding to selected of the codebook indices 252 and uses these vectors to generate representations suitable for decoding by the neural network decoder 230. The neural network decoder 230 is then used to process the output of the reconstruct module 232. The neural network decoder 230, for instance, upsamples and transforms the reconstructed features back into a reconstructed image of the original dimension, such as a 256×256 pixel image representing the atmospheric data. This process can be repeated for each of multiple images of the batched original data 201 to generate batched reconstructions 203.

In FIG. 2, the GAN discriminator includes a reconstruct module 242, which can be the same or similar to the reconstruct module 232 of the VQ-VAE. The reconstruct module 242 utilizes the codebook indices 252 and a re-embedding codebook 254 to reconstruct representations 205 suitable for decoding by an upsample neural network model 244. The re-embedding codebook 254 can optionally be of a smaller dimension than the codebook 250 of VQ-VAE. The representation 205 can be, for example, the same dimension as the output from the reconstruct module 232 of the VQ-VAE.

The representations 205 are processed, using an upsample neural network model 244 that increases the resolution or dimension of the representations 205 to generate upsampled representations 207. The upsample neural network 244, for example, can be a neural decoder that is utilized expand a 32×32 (or other dimensionality) input to a 256×256 (or other increased dimensionality) input to match the dimension of the batched original data 201 and the batched reconstructions 203. A concatenate channelwise module 246 receives the upsampled representations 207 and receives matching original data or reconstructions 209. Each of the matching original data or reconstructions 209 corresponds to one of the upsampled representations and is either one of the images of the batched original data 201 therefor or is instead one of the images of the batched reconstructions 203 therefor. For example, for a first of the upsampled representations 207 the matching original data or reconstructions 209 can include an original image corresponding thereto and for a second of the upsampled representations 307 the matching original data or reconstructions 209 can include a reconstructed original image corresponding thereto. The concatenate channelwise module 246 concatenates these two data streams along their channel dimension to create a combined input for the patch discriminator 248.

The patch discriminator 248 processes the combined input, from the concatenate channelwise module 246, to generate output 211 that reflects, on a patch-by-patch basis, a prediction of whether the patch is based on original data or a reconstruction. For example, the output 211 can include softmax classification(s) for each patch. For instance, each patch can have a single probability in the output 211, where the single probability indicates whether the corresponding patch is based on original data or reconstruction (e.g., values closer to 1 indicate original data and values closer to 0 indicate reconstruction). Put another way, the probability for each patch can indicate a prediction of whether the concatenation for that patch is a concatenation with an original image or a concatenation with a reconstructed image. As another instance, each patch can have a pair of probabilities in the output 211, with a first of the probabilities indicating a prediction of if the concatenation for that patch is with an original image and a second of the probabilities indicating a prediction of if the concatenation for that patch is with a reconstructed image. In some implementations, the output of the patch discriminator 248 is of a reduced dimension relative to the dimension of the combined input from the concatenate channelwise module 246. Accordingly, in those implementations each patch corresponds to multiple pixels of the combined input from the concatenate channelwise module 246.

The Kullback-Leibler (KL) divergence module 249 processes the output 211 and ground truth labels 256 to generate patchwise discriminator losses 213. The ground truth labels 256 are based on whether a given patch is from a corresponding original or a corresponding reconstructed image. Put another way, the ground truth labels 256 can be based on the actual known makeup of the matching original data or reconstructions 209. The patchwise discriminator losses 213 can be based on KL divergence between the output 211 and the ground truth labels 256. The patchwise discriminator losses 213 can be used in training the VQ-VAE and, optionally, in training the GAN discriminator. Through such training the VQ-VAE is trained to generate reconstructions that are more realistic. Put another way, the VQ-VAE is trained so that the GAN discriminator losses are minimized as the GAN discriminator is more unable to distinguish between real and reconstructed images generated by the VQ-VAE.

The GAN discriminator in FIG. 2 can be used to train the VQ-VAE through a large quantity (e.g., hundreds, thousands, hundreds of thousands) of iterations of processing original data. After training, the VQ-VAE can be utilized, optionally independently of the GAN discriminator, in compressing and/or decompressing spatial data as described herein.

FIG. 3 is a block diagram illustrating an example hyperprior network. The example of FIG. 3 is an additional example of an architecture that can be used in various implementations in compressing and/or decompressing spatial data as described herein. The hyperprior network includes factorized prior (FP) network (within dashed lines) that includes an FP encoder 320 that can process original images, such as HEALPix images, into a reduced dimensionality latent representation. The reduced dimensionality latent representation generated using FP encoder 320 can be processed using a scalar quantizer (Q) 322 and an arithmetic encoder (AE) 324 in generating codebook indices 352. Further, an arithmetic decoder (AD) 334 of the FP network can process codebook indices 352 to obtain dequantized data that can be processed using FP decoder 330 to generate reconstructed images 303.

In FIG. 3, the FP network is augmented by adding an additional encoder-decoder pathway that encodes the FP network's latents and decodes them to a grid of variances. More particularly, the reduced dimensionality latent representation generated using FP encoder 320 can also be processed using a convolutional (CONV) module 322 that can, for example, process the representation utilizing convolutional layer(s) to generate convolved output. The output of the CONV module 322 is then provided to a crop module 326 that can, for example, select a specific region of interest from the convolved output, to generate cropped output. The cropped output is then processed by a hyperprior (HP) encoder 326, to generate a reduced dimensionality latent representation. The reduced dimensionality latent representation generated using HP encoder 326 can be processed using a scalar quantizer (Q) 322A and an arithmetic encoder (AE) 324A in generating codebook indices 352A. Further, an arithmetic decoder (AD) 334A can process codebook indices 352A to obtain dequantized data that can be processed using HP decoder 336 to generate decoded output. The decoded output is processed using a deconvolutional (DECONV) module 332 to generate DECONV output. The DECONV module 232, for example, can upsample and/or refine the decoded output. The DECONV output can be provided to the AE 324 for utilization in generating codebook indices and/or to the AD 334 for utilization in processing codebook indices to obtain dequantized data.

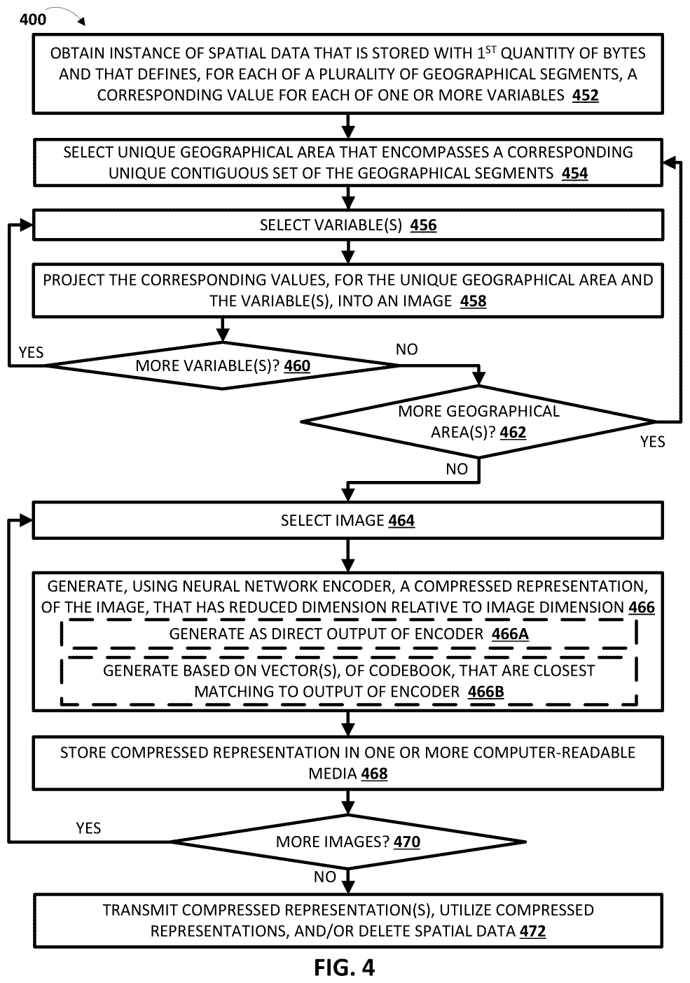

FIG. 4 is a flowchart illustrating an example method 400 for spatial data compression. As a working example for illustrating the steps of FIG. 4, consider a system at a meteorological center that processes vast quantities of atmospheric data, such as temperature, pressure, and wind speed, across a global grid at high spatial and temporal resolutions.

At block 452, the method includes obtaining an instance of spatial data that is stored with a first quantity of bytes and that defines, for each of a plurality of geographical segments of a geographic coordinate system (GCS), a corresponding value for each of one or more variables. For example, the meteorological center system can obtain atmospheric data (e.g., temperature, pressure, wind speed) for a specific time, which defines values for various geographical segments across the global grid and is stored in a high-fidelity format, occupying a first quantity of bytes, such as tens of terabytes for a single global instance. Optionally, the instance of spatial data can further define, for each of a plurality of geographical segments, corresponding elevation data reflecting a corresponding elevation of the geographic segment and/or a corresponding mask reflecting whether the geographic segment is part of a large body of water.

At block 454, the method includes selecting a unique geographical area that encompasses a corresponding unique contiguous set of the geographical segments. Continuing the example, the system selects a specific geographical area, such as all of, or a contiguous part of, North America, which corresponds to a unique contiguous set of geographical segments on the global grid.

At block 456, the method includes selecting one or more variables. For example, for the selected North America region, the system selects temperature, pressure, and wind speed as the variables to be processed. Optionally, the one or more variables can include atmospheric data variables and the corresponding values can include sensed atmospheric values corresponding to a temporal period. The atmospheric data variables can include one or more pressure variables, one or more wind speed variables, and/or one or more temperature variables. The one or more image channels can include a plurality of channels, and each of the channels can be for a corresponding one of the atmospheric data variables. This can allow for multi-channel image processing where each channel represents a distinct atmospheric property.

At block 458, the method includes projecting the corresponding values, for the unique geographical area and the one or more variables, into an image. For example, the atmospheric values (temperature, pressure, wind speed) for the selected North America region are projected into a 256×256 pixel image with multiple channels (e.g., one for temperature, one for pressure, etc.). Optionally, projecting the instance of spatial data into the plurality of images can include using a Hierarchical Equal Area iso-Latitude Pixelation (HEALPix) projection. This can transform spherical data into a square image format suitable for neural network processing while preserving equal areas. Optionally, each of the images can include corresponding padding pixels along a periphery thereof, where each of the corresponding padding pixels is for a corresponding one of the geographical segments that is included in two or more of the images. This can help to smooth transitions between adjacent images. Optionally, a given image of the images can include a given set of padding pixels that are for a subset of the geographical segments, and an additional image of the images can also include the given set of padding pixels that are for the subset of the geographical segments. This overlap facilitates seamless reconstruction across image boundaries.

At decision block 460, a determination is made as to whether there are more variables to process for the current geographical area. If there are more variables (e.g., if only temperature was processed, but pressure and wind speed remain), the method returns to block 456 to select the next variable. If there are no more variables, the method proceeds to decision block 462.

At decision block 462, a determination is made as to whether there are more geographical areas to process. If there are more geographical areas (e.g., after processing North America, Europe and oceanic expanses remain), the method returns to block 454 to select the next unique geographical area. If there are no more geographical areas, the method proceeds to block 464.

At block 464, the method includes selecting an image. For example, the system selects one of the 256×256 images generated in block 458 for compression.

At block 466, the method includes generating, using a neural network encoder, a compressed representation of the image, where the compressed representation has a reduced dimension relative to the image dimension. For example, a neural network encoder processes the selected 256×256 image and generates a 32×32 representation, which is significantly smaller than the original image. Block 466 can optionally include sub-block 466A or sub-block 466B.

At sub-block 466A, the method can include generating the compressed representation as direct output of the neural network encoder. At sub-block 466B, the method can include generating the compressed representation based on one or more vectors, of a codebook, that are closest matching to output of the neural network encoder. In some implementations, this can involve vector quantization method(s) that include comparing the encoder's output to a predefined codebook and selecting the closest matching vectors.

At block 468, the method includes storing the compressed representation in one or more computer-readable media. For example, the 32×32 compressed representation or a codebook representation is stored in a database or cloud storage. This compressed representation, along with all other compressed representations for all images, is collectively stored with a second quantity of bytes that is substantially less than the first quantity of bytes of the original spatial data. Optionally, the first quantity of bytes can be at least nine hundred times greater than the second quantity of bytes. This significant reduction in data size is a significant technical advantage, enabling efficient storage and transmission.

At decision block 470, a determination is made as to whether there are more images to process. If there are more images (e.g., if the compression loop needs to continue for other images generated in block 458), the method returns to block 464. If there are no more images, the method proceeds to block 472.

At block 472, the method can include one or more of transmitting the compressed representation(s), utilizing the compressed representations, and/or deleting the spatial data. For example, the meteorological center system can transmit the compressed representations to a remote research station for analysis, can utilize them directly for training machine learning models (e.g., training machine learning model(s) that operate directly on the compressed representations), and/or can delete the original, larger spatial data from storage to conserve resources. In some implementations, block 472 includes transmitting the corresponding compressed representations over one or more networks, thereby conserving limited network resources. In some implementations, block 472 includes processing the corresponding compressed representations, using a machine learning model, to generate one or more predictions. This enables prediction generation from the more compact data. In some implementations, block 472 includes, subsequent to storing the corresponding compressed representations, removing the instance of spatial data from storage. This replaces the storage-intensive original data with the more efficient compressed representations.

In some implementations, block 472 includes processing the corresponding compressed representation, for an image of the images, using a neural network decoder, to generate a reconstructed image that has the image dimension. In some of those implementations, the method can further include comparing reconstructed pixels of the reconstructed image to pixels of the image; determining, based on the comparing, that a reconstructed pixel differs from a corresponding one of the pixels by at least a threshold; and in response to determining that the reconstructed pixel differs from the corresponding one of the pixels by at least the threshold: storing, in the one or more computer-readable media and in association with the corresponding compressed representation of the image, the corresponding one of the pixels. This enables correction of high-error pixels by storing their original values. The method can further include, subsequent to storing, in the one or more computer-readable media and in association with the corresponding compressed representation of the image, the corresponding one of the pixels: again processing the corresponding compressed representation, for an image of the images, using a neural network decoder, to generate the reconstructed image that has the image dimension; and modifying the reconstructed image by replacing the reconstructed pixel with the corresponding one of the pixels, where replacing the reconstructed pixel with the corresponding one of the pixels is responsive to the corresponding one of the pixels being stored in association with the corresponding compressed representation, of the image, used in generating the reconstructed image.

In some implementations, the method can further include projecting the reconstructed image into the GCS, of the instance of spatial data, to generate reconstructed spatial data. This converts the image back into spatial data. Projecting the reconstructed image into the GCS, of the instance of spatial data, can include using a spherical harmonics forward transform in projecting the reconstructed image into the GCS. The method can further include determining spherical harmonics coefficients, for the spherical harmonics forward transform, based on performing a forward transform on the reconstructed image. The method can further include processing the reconstructed spatial data, using a machine learning model, to generate one or more predictions. This enables the use of the reconstructed data for downstream applications. In some implementations, the method can further include, subsequent to storing the corresponding compressed representations in the one or more computer-readable media: processing the corresponding compressed representation, for the given image, using a neural network decoder, to generate a reconstructed given image that has the image dimension and that includes a given set of reconstructed padding pixels corresponding to the given set of padding pixels; processing the corresponding compressed representation, for the additional image, using the neural network decoder, to generate a reconstructed additional image that has the image dimension and that includes an additional set of reconstructed padding pixels corresponding to the given set of padding pixels; and projecting the reconstructed given image and the reconstructed additional image into the GCS, of the instance of spatial data, to generate reconstructed spatial data, where projecting the reconstructed given image and the reconstructed additional image to generate the reconstructed spatial data includes generating the reconstructed spatial data, for the subset of the geographical segments, based on both the given set of reconstructed padding pixels and the additional set of reconstructed padding pixels. This provides accurate reconstruction of overlapping areas. Generating the reconstructed spatial data, for the subset of the geographical segments, based on both the given set of reconstructed padding pixels and the additional set of reconstructed padding pixels can include weighting the given set of reconstructed padding pixels differently from the additional set of reconstructed padding pixels. This can allow for more precise blending in overlapping regions.

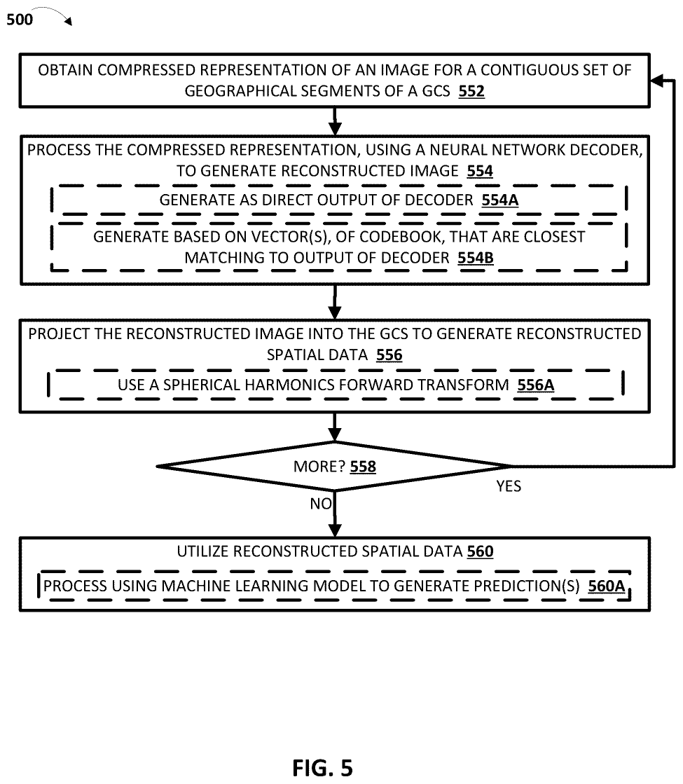

FIG. 5 is a flowchart illustrating an example method 500 for spatial data reconstruction. As a working example for illustrating the steps of FIG. 5, consider a scenario where a remote research system has successfully received compressed representations of global atmospheric conditions for a specific temporal period, where the initial values were stored with a first quantity of bytes. The research system needs to reconstruct a specific portion of this atmospheric data that was previously projected into an image representing a contiguous set of geographical segments (e.g., a specific hurricane event).

At block 552, the method includes obtaining a compressed representation of an image for a contiguous set of geographical segments of a GCS. For example, the research systems one or more processors obtain a 32×32 compressed representation of the 256×256 pixel image representing the hurricane event. This compressed representation is stored with a second quantity of bytes that is substantially less than the first quantity of bytes of the original values from the spatial data based on which the image is generated. Optionally, obtaining the compressed representation of the image can include receiving the compressed representation via one or more networks. This enables remote access to the data without needing to store the entire uncompressed dataset locally.

At block 554, the method includes processing the compressed representation, using a neural network decoder, to generate a reconstructed image. For example, the neural network decoder can be used to process the 32×32 compressed representation, upsampling and transforming it back into a 256×256 pixel reconstructed image that approximates the original atmospheric data for the hurricane event. Block 554 can include sub-block 554A or sub-block 554B. At sub-block 554A, the method can include generating the reconstructed image as direct output of the neural network decoder. Put another way, the processing using the neural network decoder can directly produce the reconstructed image. At sub-block 554B, the method can include generating the reconstructed image based on one or more vectors, of a codebook, that are closest matching to output of the neural network decoder. For example, this can involve comparing the decoder's output to a predefined codebook and selecting the closest matching vectors to generate and/or refine the reconstruction.

At block 556, the method includes projecting the reconstructed image into the GCS to generate reconstructed spatial data. For example, the 256×256 pixel reconstructed image is projected back into the GCS, converting the image representation into reconstructed spatial data (e.g., latitude/longitude grid data) of atmospheric conditions for the hurricane event. Block 556 can optionally include sub-block 556A, where the method uses a spherical harmonics forward transform in projecting the reconstructed image into the GCS. For example, spherical harmonics coefficients, that are utilized in performing the spherical harmonics forward transform, can be determined based on performing a forward transform on the reconstructed image.

At decision block 558, a determination is made as to whether there are more compressed representations to process. If there are more compressed representations (e.g., for other geographical areas or temporal periods), the method returns to block 552. If there are no more, the method proceeds to block 560.

At block 560, the method includes utilizing the reconstructed spatial data. For example, the research station system can utilize the reconstructed spatial data of the hurricane event for detailed meteorological analysis, visualization, or as input for other models.

Block 560 can include an optional sub-block 560A. At sub-block 560A, the method can include processing, using a machine learning model, to generate one or more predictions.

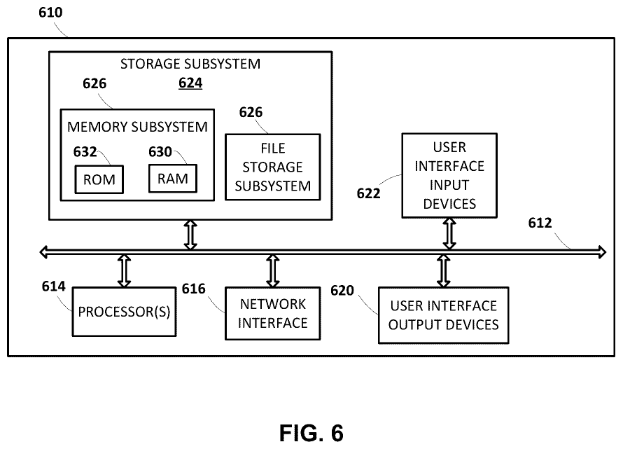

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, a use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, a use of the term “output device” is intended to include all possible types of devices and ways to output information from computer system 610 to the user or to another machine or computer system.

Storage subsystem 624 stores programming and data constructs that provide functionality of some or all of the modules described herein. For example, the storage subsystem 624 may include logic to perform selected aspects of method 400, method 500 and/or to implement one or more aspects of systems described herein. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a CD-ROM drive, an optical drive, or removable media cartridges. Modules implementing functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple buses.

Computer system 610 can be of varying types including a workstation, server, computing cluster, blade server, server farm, smart phone, smart watch, smart glasses, set top box, tablet computer, laptop, or any other data processing system or computing device. Due to an ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

In some implementations a method implemented by processor(s) is provided and includes obtaining an instance of spatial data. The instance of spatial data is stored with a first quantity of bytes and defines, for each of a plurality of geographical segments of a geographic coordinate system (GCS), a corresponding value for each of one or more variables. The method further includes projecting the instance of spatial data into a plurality of images. Each of the images is for a corresponding unique geographical area that encompasses a corresponding unique contiguous set of the geographical segments and is generated based on projecting the corresponding values for the corresponding unique contiguous set of the geographical segments. Further, each of the images has an image dimension that includes one or more image channels and a height and a width for each of the image channels. The method further includes generating, using a neural network encoder, a corresponding compressed representation for each of the images. Each of the corresponding compressed representations have a reduced dimension that is reduced relative to the image dimension. The corresponding compressed representations are collectively stored with a second quantity of bytes that is lesser than the first quantity of bytes with which the instance of spatial data is stored. The method further includes storing the corresponding compressed representations in one or more computer-readable media.

These and other implementations disclosed herein can include one or more of the following features.

In some implementations, the method further includes transmitting the corresponding compressed representations over one or more networks (e.g., the Internet). Transmitting the corresponding compressed representations (with the lesser quantity of second bytes) can occur in lieu of transmitting the instance of spatial data (with the greater quantity of first bytes), thereby conserving limited network resources.

In some implementations, the method further includes processing the corresponding compressed representations, using a machine learning model, to generate one or more predictions. For example, the compressed representations can be processed using a neural network model to generate a prediction that reflects a prediction of future spatial data for one or more of the geographical segments.

In some implementations, the method further includes, subsequent to storing the corresponding compressed representations, removing the instance of spatial data from storage. In these and other manners the more storage intensive instance of spatial data is replaced by the more storage efficient corresponding compressed representations.

In some implementations, the one or more variables include atmospheric data variables and the corresponding values include sensed atmospheric values corresponding to a temporal period. In some of those implementations, the atmospheric data variables can include one or more pressure variables, one or more wind speed variables, and/or one or more temperature variables. In some versions of those implementations, the one or more channels of the image include a plurality of channels and each of the channels is for a corresponding one of the atmospheric data variables.

In some implementations, each of the plurality of geographical segments is a corresponding portion of the Earth that is 1 kilometer or less in area, such as a square (or other shape) portion that is 0.5 kilometer or less in area.

In some implementations, projecting the instance of spatial data into the plurality of images includes using a Hierarchical Equal Area iso-Latitude Pixelation (HEALPix) projection in projecting the instance of spatial data into the plurality of images.

In some implementations, generating, using the neural network encoder, the corresponding compressed representation for each of the images includes generating the corresponding compressed representation as direct output of the neural network encoder.

In some implementations, generating, using the neural network encoder, the corresponding compressed representation for each of the images includes comparing direct output of the neural network encoder to a codebook of multiple vectors, and generating the corresponding compressed representation based on one or more closest matching of the multiple vectors of the codebook.

In some implementations, the first quantity of bytes is at least nine hundred times greater than the second quantity of bytes. For example, the first quantity of bytes can be at least one thousand times greater than the second quantity of bytes.

In some implementations, the corresponding unique contiguous set of the geographical segments utilized in generating a first image of the images include a subset of one or more geographical segments that are also utilized in generating a second image of the images. For example, N geographical segments can be utilized in generating first padding pixels on one side of the first image and the same N geographical segments can be utilized in generating second padding pixels on a second side of the first image. Accordingly, while the geographic areas represented by the first and second images can be unique, they will include partially overlapping geographic areas, as represented by the first and second padding pixels.

In some implementations, the method further includes, subsequent to storing the corresponding compressed representations in the one or more computer-readable media, processing the corresponding compressed representation, for an image of the images, using a neural network decoder, to generate a reconstructed image that has the image dimension. In some versions of those implementations, the method further includes: comparing reconstructed pixels of the reconstructed image to pixels of the image; determining, based on the comparing, that a reconstructed pixel differs from a corresponding one of the pixels by at least a threshold; and in response to determining that the reconstructed pixel differs from the corresponding one of the pixels by at least the threshold: storing, in the one or more computer-readable media and in association with the corresponding compressed representation of the image, the corresponding one of the pixels. In some of those versions, the method further includes, subsequent to storing, in the one or more computer-readable media and in association with the corresponding compressed representation of the image, the corresponding one of the pixels: again processing the corresponding compressed representation, for an image of the images, using the neural network decoder, to generate the reconstructed image that has the image dimension; and modifying the reconstructed image by replacing the reconstructed pixel with the corresponding one of the pixels. Replacing the reconstructed pixel with the corresponding one of the pixels is responsive to the corresponding one of the pixels being stored in association with the corresponding compressed representation, of the image, used in generating the reconstructed image.

In some implementations, the method further includes, subsequent to storing the corresponding compressed representations in the one or more computer-readable media: processing the corresponding compressed representation, for an image of the images, using a neural network decoder, to generate a reconstructed image that has the image dimension; and projecting the reconstructed image into the GCS, of the instance of spatial data, to generate reconstructed spatial data. In some versions of those implementations, projecting the reconstructed image into the GCS, of the instance of spatial data, includes using a spherical harmonics forward transform in projecting the reconstructed image into the GCS. In some of those versions, the method further includes determining spherical harmonics coefficients, for the spherical harmonics forward transform, based on performing a forward transform on the reconstructed image. In some of those or other versions, the method further includes processing the reconstructed spatial data, using a machine learning model, to generate one or more predictions.

In some implementations, the instance of spatial data further defines, for each of a plurality of geographical segments, corresponding elevation data reflecting a corresponding elevation of the geographic segment and/or a corresponding mask reflecting whether the geographic segment is part of a large body of water.

In some implementations, each of the images includes corresponding padding pixels along a periphery thereof. Each of the corresponding padding pixels is for a corresponding one of the geographical segments that is included in two or more of the images.

In some implementations, a given image of the images includes a given set of padding pixels that are for a subset of the geographical segments and an additional image of the images also includes the given set of padding pixels that are for the subset of the geographical segments. In some of those implementations, the method further includes, subsequent to storing the corresponding compressed representations in the one or more computer-readable media: processing the corresponding compressed representation, for the given image, using a neural network decoder, to generate a reconstructed given image that has the image dimension and that includes a given set of reconstructed padding pixels corresponding to the given set of padding pixels; processing the corresponding compressed representation, for the additional image, using the neural network decoder, to generate a reconstructed additional image that has the image dimension and that includes an additional set of reconstructed padding pixels corresponding to the given set of padding pixels; and projecting the reconstructed given image and the reconstructed additional image into the GCS, of the instance of spatial data, to generate reconstructed spatial data. Projecting the reconstructed given image and the reconstructed additional image to generate the reconstructed spatial data can include generating the reconstructed spatial data, for the subset of the geographical segments, based on both the given set of reconstructed padding pixels and the additional set of reconstructed padding pixels. For example, generating the reconstructed spatial data, for the subset of the geographical segments, based on both the given set of reconstructed padding pixels and the additional set of reconstructed padding pixels can include weighting the given set of reconstructed padding pixels differently from the additional set of reconstructed padding pixels

In some implementations a method implemented by processor(s) is provided and includes obtaining a compressed representation of an image. The image is generated based on projecting values, from spatial data, for a contiguous set of geographical segments a geographic coordinate system (GCS). The compressed representation is stored with a second quantity of bytes that is lesser than a first quantity of bytes of the values on which the image is generated. The method further includes processing the compressed representation, using a neural network decoder, to generate a reconstructed image. The method further includes projecting the reconstructed image into the GCS to generate reconstructed spatial data.

These and other implementations disclosed herein can include one or more of the following features.

In some implementations, obtaining the compressed representation of the image includes receiving the compressed representation via one or more networks.

In some implementations, projecting the reconstructed image into the GCS, of the instance of spatial data, includes using a spherical harmonics forward transform in projecting the reconstructed image into the GCS. In some of those implementations, the method further includes determining spherical harmonics coefficients, for the spherical harmonics forward transform, based on performing a forward transform on the reconstructed image.

In some implementations, the method further includes processing the reconstructed spatial data, using a machine learning model, to generate one or more predictions.

In some implementations, processing the compressed representation, using the neural network decoder, to generate the reconstructed image includes generating the reconstructed image as direct output of the neural network decoder.

In some implementations, processing the compressed representation, using the neural network decoder, to generate the reconstructed image includes comparing direct output of the neural network decoder to a codebook of multiple vectors, and generating the reconstructed image based on one or more closest matching of the multiple vectors of the codebook.

Several implementations described herein relate to methods for performing selected aspects of the present disclosure. Other implementations may include one or more transitory or non-transitory computer readable storage media storing instructions executable by a processor to perform a method such as one or more of the methods described herein. Yet another implementation may include a control system including memory and one or more processors operable to execute instructions, stored in the memory, to implement one or more modules or engines that, alone or collectively, perform a method such as one or more of the methods described herein.

What is claimed is:

1. A method implemented by one or more processors, the method comprising:
obtaining an instance of spatial data that is stored with a first quantity of bytes and that defines, for each of a plurality of geographical segments of a geographic coordinate system (GCS), a corresponding value for each of one or more variables;
projecting the instance of spatial data into a plurality of images,
each of the images being for a corresponding unique geographical area that encompasses a corresponding unique contiguous set of the geographical segments and being generated based on projecting the corresponding values for the corresponding unique contiguous set of the geographical segments, and
each of the images having an image dimension that includes one or more image channels and a height and a width for each of the image channels;
generating, using a neural network encoder, a corresponding compressed representation for each of the images,
wherein each of the corresponding compressed representations have a reduced dimension that is reduced relative to the image dimension, and
wherein the corresponding compressed representations are collectively stored with a second quantity of bytes that is lesser than the first quantity of bytes with which the instance of spatial data is stored; and
storing the corresponding compressed representations in one or more computer-readable media.

2. The method of claim 1, further comprising transmitting the corresponding compressed representations over one or more networks.

3. The method of claim 1, further comprising processing the corresponding compressed representations, using a machine learning model, to generate one or more predictions.

4. The method of claim 1, further comprising, subsequent to storing the corresponding compressed representations, removing the instance of spatial data from storage.

5. The method of claim 1, wherein the one or more variables include atmospheric data variables and the corresponding values include sensed atmospheric values corresponding to a temporal period.

6. The method of claim 5, wherein the atmospheric data variables include one or more pressure variables, one or more wind speed variables, and/or one or more temperature variables.

7. The method of claim 6, wherein the one or more channels of the image include a plurality of channels and wherein each of the channels is for a corresponding one of the atmospheric data variables.

8. The method of claim 1, wherein each of the plurality of geographical segments is a corresponding portion of the Earth that is 1 kilometer or less in area.

9. The method of claim 1, wherein projecting the instance of spatial data into the plurality of images comprises using a Hierarchical Equal Area iso-Latitude Pixelation (HEALPix) projection in projecting the instance of spatial data into the plurality of images.

10. The method of claim 1, where generating, using the neural network encoder, the corresponding compressed representation for each of the images comprises generating the corresponding compressed representation as direct output of the neural network encoder.

11. The method of claim 1, where generating, using the neural network encoder, the corresponding compressed representation for each of the images comprises comparing direct output of the neural network encoder to a codebook of multiple vectors, and generating the corresponding compressed representation based on one or more closest matching of the multiple vectors of the codebook.

12. The method of claim 1, wherein the first quantity of bytes is at least nine hundred times greater than the second quantity of bytes.

13. The method of claim 1, wherein the corresponding unique contiguous set of the geographical segments utilized in generating a first image of the images include a subset of one or more geographical segments that are also utilized in generating a second image of the images.

14. The method of claim 1, further comprising:
subsequent to storing the corresponding compressed representations in the one or more computer-readable media:
processing the corresponding compressed representation, for an image of the images, using a neural network decoder, to generate a reconstructed image that has the image dimension.

15. The method of claim 14, further comprising:
comparing reconstructed pixels of the reconstructed image to pixels of the image;
determining, based on the comparing, that a reconstructed pixel differs from a corresponding one of the pixels by at least a threshold; and
in response to determining that the reconstructed pixel differs from the corresponding one of the pixels by at least the threshold:
storing, in the one or more computer-readable media and in association with the corresponding compressed representation of the image, the corresponding one of the pixels.

16. The method of claim 15, further comprising:
subsequent to storing, in the one or more computer-readable media and in association with the corresponding compressed representation of the image, the corresponding one of the pixels:
again processing the corresponding compressed representation, for an image of the images, using a neural network decoder, to generate the reconstructed image that has the image dimension; and
modifying the reconstructed image by replacing the reconstructed pixel with the corresponding one of the pixels, wherein replacing the reconstructed pixel with the corresponding one of the pixels is responsive to the corresponding one of the pixels being stored in association with the corresponding compressed representation, of the image, used in generating the reconstructed image.

17. The method of claim 14, further comprising:
projecting the reconstructed image into the GCS, of the instance of spatial data, to generate reconstructed spatial data.

18. The method of claim 17, wherein projecting the reconstructed image into the GCS, of the instance of spatial data, comprises using a spherical harmonics forward transform in projecting the reconstructed image into the GCS.

19. The method of claim 18, further comprising determining spherical harmonics coefficients, for the spherical harmonics forward transform, based on performing a forward transform on the reconstructed image.

20. A method implemented by one or more processors, the method comprising:
obtaining a compressed representation of an image,
wherein the image is generated based on projecting values, from spatial data, for a contiguous set of geographical segments a geographic coordinate system (GCS), and
wherein the compressed representation is stored with a second quantity of bytes that is lesser than a first quantity of bytes of the values on which the image is generated;
processing the compressed representation, using a neural network decoder, to generate a reconstructed image; and
projecting the reconstructed image into the GCS to generate reconstructed spatial data.
